(19) United States
(12) Patent Application Publication
(10) Pub. No.: US 2026/0071741 A1
(43) Pub. Date: Mar. 12, 2026

(54) A LUMINAIRE FOR A TRACK LIGHTING SYSTEM

(71) Applicant: SIGNIFY HOLDING B.V., EINDHOVEN (NL)

(72) Inventors: TIES VAN BOMMEL, HORST (NL); PETER JOHANNES MARTINUS BUKKEMS, DEURNE (NL)

(21) Appl. No.: 19/106,829

(22) PCT Filed: Aug. 18, 2023
(86) PCT No.: PCT/EP2023/072786

§ 371 Date: Feb. 26, 2025

(30) Foreign Application Priority Data
Aug. 30, 2022 (EP) 22192746.0

(51) Int. Cl. F21V 21/34

(52) U.S. Cl. CPC F21V 21/34

(57) ABSTRACT

The invention provides a luminaire configured to be connected to a track of a track lighting system that is mounted to a mounting surface, wherein the luminaire comprises: a back surface facing the track when the luminaire is connected to said track; a planar light exit window arranged opposite to the back surface; a connector connected to the back surface and protruding a connector length away from the back surface, wherein the connector is configured to connect the luminaire mechanically and electrically to said track; at least one spacer element connected to the back surface and protruding a spacer length away from the back surface, wherein the at least one spacer element is configured to contact the mounting surface when the luminaire is connected to said track.

### FIELD OF THE INVENTION

The invention relates to a luminaire configured to be connected to a track of a track lighting system. The invention further relates to a track lighting system comprising a track and at least one luminaire according to the invention. The invention further relates to a corresponding method of connecting such a luminaire to a track of a track lighting system.

### BACKGROUND OF THE INVENTION

Track lighting systems, in which track-lighting devices such as luminaires are fitted on tracks, are well known to provide great flexibility and adaptability, because the number of track-lighting devices and/or the positioning of track-lighting devices may be varied on the track.

Track lighting systems are typically implemented in professional venues. The luminaires currently implemented in track-lighting systems are mostly point sources connected at individual points on the track. A typical example of such a track-lighting system is for example a retail environment with multiple spotlights on a lighting track.

A current trend in the lighting business is to mount large-area luminaires to the track of a track-lighting system, such as for example a light panel. Another trend is that track-lighting systems are more and more implemented in domestic environments, such as within a living room and/or a kitchen. Due to their (large-area) dimensions, it may be cumbersome to mount large-area luminaires ergonomically to a track. Due to the larger dimensions of large-area luminaires relative to the track, such as light panels, it may also be more difficult to establish and/or maintain a desired orientation thereof.

As track-lighting systems become more popular and widespread, and because large-area luminaires (such as for example light panels) cope with said disadvantages in mounting and/or orienting, there is a clear need to find less cumbersome, and more ergonomic solutions in connecting track-lighting devices to the track of a track lighting system.

### SUMMARY OF THE INVENTION

It is an object of the invention to provide an improved luminaire configured to be connected to a track of a track lighting system, which at least alleviates the problems and disadvantages mentioned above. Thereto, the invention provides, a luminaire configured to be connected to a track of a track lighting system that is mounted to a mounting surface, wherein the luminaire comprises: a back surface facing the track when the luminaire is connected to said track; a planar light exit window arranged opposite to the back surface; a connector connected to the back surface and protruding a connector length away from the back surface, wherein the connector is configured to connect the luminaire mechanically and electrically to said track; at least one spacer element connected to the back surface and protruding a spacer length away from the back surface, wherein the at least one spacer element is configured to contact the mounting surface when the luminaire is connected to said track.

It is further an object of the invention to provide an improved track lighting system, which at least alleviates the problems and disadvantages mentioned above. Thereto, the invention provides a track lighting system comprising: a track that is mounted to a mounting surface; a luminaire according to the invention; wherein the at luminaire is mechanically and electrically connected to said track, wherein the at least one spacer element of said luminaire contacts the mounting surface when the luminaire is connected to said track. Thereby, advantages and/or embodiments applying to the luminaire according to the invention may mutatis mutandis apply to said track lighting system according to the invention.

Hence, the invention provides a luminaire configured to be connected to a track of a track lighting system. The track is mounted to a mounting surface. The track may thereby be mounted on, or recessed in, the mounting surface. Throughout the application, said track may be phrased alternatively as a power track of a track lighting system.

The luminaire comprises back surface. The back surface faces the track when the luminaire is connected to said track. The luminaire also comprises a planar light exit window arranged opposite to the back surface. The light exit window is configured to convey light in operation. The luminaire also comprises a connector protruding a connector length away from the back surface. The connector enables to connect the luminaire mechanically and an electrically to the track of the track lighting system. The connector may therefore be connected to a connection point on said track.

The luminaire according to the invention further comprises at least one spacer element connected to the back surface of the luminaire and protruding a spacer length away from the back surface. As the back surface faces the track when the luminaire is connected (or: mounted) to the track, the back surface also faces the mounting surface. Therefore, the at least one spacer element is configured to contact the mounting surface when the luminaire is connected to the track.

This is clearly advantageous. Since the luminaire comprises at least one spacer element in addition to the connector, and because at least one spacer element is configured to contact the mounting surface when the luminaire is connected to the track, the luminaire can more ergonomically be aligned with the mounting surface, upon connecting the connector to said track.

Moreover, the at least one spacer element may serve as an initial support for the luminaire, after which the connector of the luminaire may be connected mechanically and electrically to said track. This may facilitate a safe installation of the luminaire to the track.

Moreover, after installation, when the connector of the luminaire is mechanically and electrically connected to the track, because the at least one spacer element contacts the mounting surface, the at least one spacer element will advantageously constraint at least one degree of moment of the luminaire, especially a rotation (or: tilt) of the luminaire around the connection point at which the connector is connected to the track. This may advantageously facilitate maintaining the orientation of the luminaire substantially fixed (or: constant) relative to the mounting surface). This may render more stability.

For example, when the luminaire is connected to the track, the at least one spacer element will contact the mounting surface as well, thereby establishing a first mechanical contact point at the connection point of the connector with the track, and at least one further mechanical contact point at the point where the at least one spacer element contacts the mounting surface. Multiple contact points constrain the movement of the luminaire when connected to the track, especially the rotation (or: tilt) of the luminaire around the connection point at which the connector is connected to the track. The at least one spacer element may therefore facilitate to maintain the orientation of the luminaire substantially fixed relative to the mounting surface. This renders more stability. This is particularly advantageous for large area luminaires, such as for example light panels, of which an edge of the panel may extend a substantial distance away from the connection point at which the connector is connected to the track, compared to point-source luminaires (such as e.g. spotlights). Moreover, such multiple contact points, as mentioned above, may for example further provide a support, before connecting (e.g. clicking) the luminaire to the track.

The luminaire according to the present invention may for example be a light panel, or an elongated light bar. Such a light panel may comprise an outline defining a square shape, rectangular shape, triangular shape, polygonal shape, circular shape, elliptical shape, or free-form shape.

In some examples, the connector may protrude further away from the back surface than the at least one spacer element. In alternative examples, the at least one spacer element may protrude further away from the back surface than the connector.

In some examples, the at least one spacer element may be detachable connected to the back surface, thereby serving as an add-on feature or add-on module to the luminaire. Alternatively, the at least one spacer element may be monolithic with said back surface, such that the back surface of the luminaire may be manufactured from a single piece of material.

In an embodiment, the spacer length of the at least one spacer element is adjustable from a first spacer length to a second spacer length.

Hence, the at least one spacer element is adjustable in spacer length. This may be advantageous. Namely, when connecting the luminaire to the track, the at least one spacer element may contact the mounting surface before the connector is mechanically and electrically connected to the track. This enables alignment, support, but also tactile feedback, for an installer connecting (or: mounting) the luminaire to the track. Due to said tactile feedback, for example, the installer may learn that the connector of the luminaire approaches a corresponding connection point relative to the track when the tactile feedback of the at least one spacer element (arising from the at least one spacer element making contact with the mounting surface) is experienced.

Furthermore, any skewed alignment of the luminaire may be more easily be noted by an installer during installation. Namely, in some envisioned examples, when the luminaire is connected to the track under a skewed angle relative to the mounting surface, a first spacer element of the at least one spacer element may be adjusted in spacer length (i.e. deform or contract) before another, second, spacer element of the at least one spacer element. This may enable an installer to experience a larger (reactive) force at the location of the first spacer element before the second spacer element, thereby receiving tactile feedback that the luminaire may not be aligned relative to the mounting surface.

In an embodiment, the spacer length may be defined in a direction perpendicular to the planar light exit window. Similarly, in an embodiment, the connector length may be defined in a direction perpendicular to the planar light exit window.

In an embodiment, the back surface may be parallel to the planar light exit window.

In an embodiment, each spacer element of the at least one spacer element comprises a same first spacer length. Hence, the first spacer length may be considered an initial spacer length. The first spacer length may be the length of the at least one spacer element when at rest, or when in an unadjusted state, or when in an undeformed state.

In an embodiment, the first spacer length and the second spacer length differ at least a factor 1.2 in length. In an embodiment, the first spacer length and the second spacer length differ at most a factor 5 in length, preferably at most a factor 3, most preferably a factor 2.5.

As mentioned above, the luminaire according to the present invention comprises at least one spacer element configured to contact the mounting surface when the luminaire is connected to said track. More specifically, in an embodiment, the at least one spacer element may comprise: a base connected to the back surface, a tip configured to contact the mounting surface when the luminaire is connected to said track, a body extending between said base and said tip.

Hence, the tip is configured to contact the mounting surface when the luminaire is connected to said track. Therefore, in an embodiment, the tip may comprise a rubber or a textile. Such a rubber or a textile may prevent damage or scratches to the mounting surface. Such a rubber or textile may also prevent slipping of the luminaire when mounting the luminaire to the track of the track lighting system and/or said mounting surface.

Additionally or alternatively, in an embodiment, the tip may comprise an adhesive layer configured to establish an adhesive contact between the (tip of the) at least one spacer element and the mounting surface. Such an adhesive layer may provide more robustness to said connection.

Additionally or alternatively, in an embodiment, the tip may comprise a texture. The texture may be configured to increase friction in the contact between the tip and the mounting surface. Such a texture may also prevent slipping of the luminaire when mounting the luminaire to the track of the track lighting system and/or said mounting surface.

In alternative examples, the spacer length may be defined as the shortest length between the back surface and said tip. Yet alternatively, in other examples, the spacer length may be defined as the distance between the base and the tip. However, preferably, as partly mentioned before, the spacer length may be defined in a direction perpendicular to the planar light exit window.

As mentioned, the spacer length of the at least one spacer element is adjustable from a first spacer length to a second spacer length. The at least one spacer element may for example be adjustable based on elastic deformation.

In an embodiment, the body may be configured to elastically deform upon forced; wherein the spacer length of the at least one spacer element is adjustable from the first spacer length to the second spacer length by controlling a force on the tip.

Said controlling a force on the tip may be caused by the back surface of the luminaire being moved to the mounting surface, thereby pushing the at least one spacer element towards the base. Alternatively, said controlling a force on the tip may be caused by a manual force applied by e.g. an installer to set the spacer length.

In a first related embodiment, the body may comprise a spring configured to elastically deform upon forced; wherein the spacer length of the at least one spacer element is adjustable from the first spacer length to the second spacer length by forcing the tip towards the base. The spring may for example be a plate spring or a coil spring. In other words, in examples, the body may for example comprise a flexible (or: bendable) sheet metal.

In a second related embodiment, the body may comprise a rubber configured to elastically deform upon forced; wherein the spacer length of the at least one spacer element is adjustable from the first spacer length to the second spacer length by forcing the tip towards the base.

As mentioned, the spacer length of the at least one spacer element is adjustable from a first spacer length to a second spacer length. The at least one spacer element may for example be adjustable based on plastic deformation.

In an embodiment, the body may be configured to plastically deform upon forced; wherein the spacer length of the at least one spacer element is adjustable from the first spacer length to the second spacer length by controlling a force on the tip. The body may for example comprise a body material, the body material being a metal, or a plastic, or a wood (such as paper, or cardboard). In aspects, the body may comprise a deformable mesh, or a deformable structure. In aspects, said at least one spacer element may be 3D printed.

Considering the embodiments in which the at least one spacer element may be adjustable based on elastically or plastically deformation, a further exemplar embodiment may provide in that the second spacer length may be shorter than the first spacer length. Hence, the at least one spacer element may be contracted, pressed, shrunk, etc. based on contact with the mounting surface, wherein the luminaire is moved (or: pushed) towards said mounting surface.

Considering the embodiments in which the at least one spacer element may be adjustable based on elastically or plastically deformation, said deformation may be characterized as from a first undeformed state into a second deformed state. Hence, the first spacer length may be the spacer length at (or correspond to) an undeformed sate (of the body), whereas the second spacer length may be the spacer length at (or correspond to) a deformed state (of the body).

As mentioned, the spacer length of the at least one spacer element is adjustable from a first spacer length to a second spacer length. The at least one spacer element may for example be adjustable based on a mechanical construction.

For example, in an embodiment, the body may comprise a socket comprising an inner thread and a rod comprising an outer thread; wherein the rod is arranged coaxial with the socket; wherein the outer thread of the rod engages the inner thread of the socket; wherein the rod may be configured to move in a direction towards to the base by rotating the rod in a first rotational direction within the socket, and wherein the rod may be configured to move in a direction away from the base by rotating the rod in a second rotational direction within the socket; wherein the second rotational direction is opposite to the first rotational direction; wherein the spacer length of the at least one spacer element is adjustable from the first spacer length to the second spacer length by rotating the rod within the socket.

Said first rotational direction may for example be clockwise and the second rotational direction may for example be anticlockwise, or vice versa.

Alternatively, in other examples, the body may comprise a telescopic rod, wherein the spacer length of the at least one spacer element is adjustable from the first spacer length to the second spacer length by extending or contracting the telescopic rod.

Alternatively, in other examples, the body may comprise a socket and a rod, wherein the rod is arranged coaxial with the socket, wherein the rod is movable within the socket in the direction towards the base, wherein the rod is lockable within the socket, wherein the spacer length of the at least one spacer element is adjustable from the first spacer length to the second spacer length by moving the rod within the socket and locking the rod within the socket. Yet alternatively, said rod may be press-fitted within the socket, or said rod may be click-fitted within the socket.

As mentioned above, the luminaire according to the present invention comprises at least one spacer element configured to contact the mounting surface when the luminaire is connected to said track. The luminaire also comprises a connector configured to connect the luminaire mechanically and electrically to said track. The at least one spacer element and the connector are both arranged on the back surface, and protrude respectively a spacer length and connector length away from the back surface.

In an embodiment, the back surface comprises an outline; wherein the at least one spacer element may be arranged closer to the outline than to the connector. Such an embodiment is advantageous, because the at least one spacer element may provide support and/or alignment close to the periphery or outline of the back surface, which are locations suited for such support and/or alignment (especially for large-area luminaires).

In other embodiments, the back surface may comprise an outline; wherein each spacer element of the at least one spacer element may be located at a respective spacer location on the back surface; wherein the shortest distance between each respective spacer location and the outline is at least equal to the spacer length. Hence, the at least one spacer element may be kept substantially out of view when the luminaire is connected to the mounting surface. For example, such an embodiment may be advantageous, because the at least one spacer element will be offset from the perimeter of the back surface, thereby not being visible from a wider angle below the luminaire, when mounted to the track.

In other embodiments, the back surface may comprise a geometric center; wherein the at least one spacer element comprises a first spacer element arranged at a first spacer location on the back surface and a second spacer element arranged at a second spacer location on the back surface; wherein the first spacer location is symmetric to the second spacer relative to a symmetry plane through the geometric center. Such an embodiment may provide more stability and alignment due to the symmetrically aligned at least one spacer element. Such a symmetric configuration may be advantageous for alignment, as the first spacer and second spacer are optimally positioned on the whole back surface of the luminaire. In aspects, the first spacer location and said second spacer location may be antipodal.

As mentioned above, the luminaire comprises a connector. The connector is connected to the back surface and protruding a connector length away from the back surface. The connector is configured to connect the luminaire mechanically and electrically to said track.

In an embodiment, the connector may be located at a geometric center of the back surface. Alternatively, in an embodiment, the connector may be located offset from a geometric center of the back surface. Such an embodiment may enable asymmetrically connected luminaires to a track lighting system, while the at least one spacer element according to the present invention may provide a more ergonomic installation and/or alignment relative to the track.

In an embodiment, the connector length of the connector is adjustable from a first connector length to a second connector length. Hence, the connector is adjustable in connector length. This may be advantageous. Namely, when connecting the luminaire to the track, connector may electrically and mechanically connect the luminaire to the track and subsequently pull the luminaire towards the mounting surface. The at least one spacer element may thereby facilitate the correct alignment of the luminaire.

More specifically, in an embodiment, the connector may comprise: a foot connected to the back surface, a head configured to connect the luminaire mechanically and electrically to said track, an extendable member extending between said foot and said head; wherein the extendable member may comprise a spring lock configured to switch between a locked state and a released state; wherein, in the locked state, the connector has the first connector length; wherein, in the released state, the connector has the second connector length; wherein the second connector length is shorter than the first connector length.

It is further an object of the invention to provide an improved method, which at least alleviates the problems and disadvantages mentioned above. Thereto, the invention provides a method of connecting a luminaire according to the invention to a track of a track lighting system that is mounted to a mounting surface, wherein the method comprises: mechanically and electrically connecting the luminaire to said track; adjusting a first spacer length of the at least one spacer element to a second spacer length of the at least one spacer element. Thereby, advantages and/or embodiments applying to the luminaire and/or track lighting system according to the invention may mutatis mutandis apply to method according to the invention.

### BRIEF DESCRIPTION OF THE DRAWINGS

The invention will now be further elucidated by means of the schematic non-limiting drawings:

FIG. 1A and FIG. 1B depicts schematically an embodiment of a track lighting system according to the invention;

FIG. 2A and FIG. 2B depicts schematically an embodiment of a track lighting system according to the invention;

FIG. 3A and FIG. 3B depicts schematically an embodiment of a track lighting system according to the invention;

FIG. 4A and FIG. 4B depicts schematically an embodiment of a track lighting system according to the invention;

FIG. 5 depicts schematically an embodiment of a luminaire according to the invention;

FIG. 6 depicts schematically an embodiment of a track lighting system according to the invention;

FIG. 7 depicts schematically an embodiment of a method according to the invention.

### DETAILED DESCRIPTION OF THE EMBODIMENTS

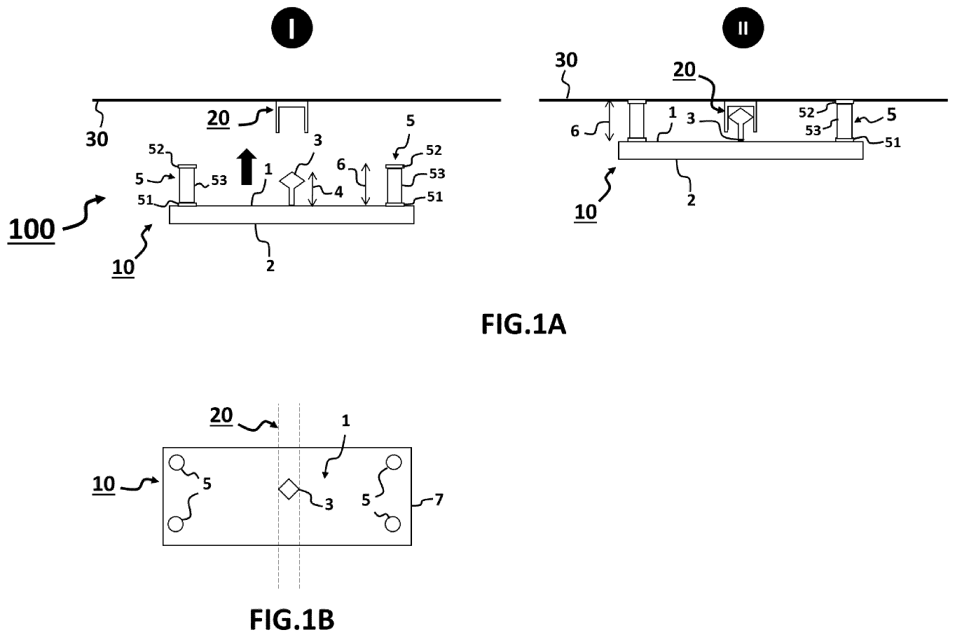

FIG. 1A depicts schematically, by non-limiting example, an embodiment of a track lighting system 100 according to the invention. The track lighting system 100 comprises a luminaire 10 and a track 20. The luminaire 10 is configured to be mechanically and/or electrically connect to said track 20. FIG. 1A depicts a sideview, of a first situation I in which the luminaire 10 is to be connected to the track 20, and of a second situation II in which the luminaire 10 is connected to the track 20. Furthermore, FIG. 1B depicts schematically, by non-limiting example, a top view of said embodiment.

The track lighting system 100 comprises a luminaire 10 and a track 20. The track 20 is mounted to a mounting surface 30. The track 20 is thereby mounted on the mounting surface 30. Alternatively, the track may at least partly be recessed in said mounting surface. The track 20 may be phrased as a power track. The track may comprise a cathode track and an anode track for powering the luminaire 10. The principles of a track lighting systems as such may be known in the art.

The luminaire 10 according to the invention comprises a back surface 1 and a planar light exit window 2. The planar light exit window 2 conveys light in operation. In aspects, said back surface may also be substantially planar, but that is not necessary. The back surface 1 faces the track 20, and consequently the mounting surface 30, when the luminaire 10 is connected to said track 20. The planar light exit window 2 is arranged opposite to the back surface 1. In the present embodiment, the luminaire 10 is a light panel. Alternatively, the luminaire may be an elongated light bar. The luminaire (i.e. light panel) comprises a rectangular light exit window 2. The back surface 1 of the luminaire 10 comprises outline 7, wherein the outline 7 of the back surface 1 is also rectangular.

Still referring to FIG. 1A and FIG. 1B, the luminaire 10 comprises a connector 3. The connector 3 is connected to the back surface 1 and protrudes a connector length 4 away from the back surface 1. Here, the connector length 4 is defined in a direction perpendicular to the planar light exit window 2. The connector length is thereby defined as the shortest distance between the location where the connector (is connected and) protrudes away from the back surface 1 and an (free extending) utmost point of the connector 3. The connector 3 is configured to connect the luminaire 10 mechanically and electrically to said track 20. Such connections are known in the art. Alternatively, such outlines may be a square, a triangle, a polygon, a circle, an ellipse, a free-form, or at least a combination of these shapes. For example, a rectangle with rounded corners.

According to the invention, the luminaire 10 further comprises at least one spacer element 5. The at least one spacer element 5 is connected to the back surface 1 and protrudes a spacer length 6 away from the back surface 1. The spacer length 6 is also defined in a direction perpendicular to the planar light exit window 2.

As mentioned, the at least one spacer element 5 is connected to the back surface 1 and protrudes a spacer length 6 away from the back surface 1. More specifically, the at least one spacer element 5 comprises a base 51 connected to the back surface 1, a tip 52, and a body 53 extending between said base 51 and said tip 52. The at least one spacer element 5, and here in particular the tip 52, contacts (or: is configured to contact) the mounting surface 30 when the luminaire 10 is connected to said track 20. See situation referred as II.

Still referring to FIG. 1A and FIG. 1B, albeit optionally, the tip 52 of the at least one spacer element 5 comprises a rubber or a textile. Hence, when the luminaire 10 is connected to said track 20, the tip 52 does not damage the mounting surface 30 with said contact.

Here, the back surface of the luminaire 10 comprises four spacer elements connected thereto, wherein said spacer elements are arranged substantially in the four corners (areas) defined by said rectangular outline 7. The at least one spacer element 5 is thereby arranged closer to the outline 7 of the back surface 1 than to the connector 3. Thereby, albeit not necessarily, each spacer element 5 is located at a respective spacer location on the back surface 1, wherein the shortest distance between each respective spacer location and the outline 7 is at least equal to the spacer length 6. Alternatively, said luminaire may comprise one, two, three, or at least four spacer elements. The spacer length may alternatively be defined as the distance between the base and said tip.

Still referring to FIG. 1B, the back surface 1 comprises a geometric center. The connector 3 is arranged at said geometric center. The four spacer elements are symmetric to each other relative to a symmetry plane through the geometric center.

Here, the at least one spacer element 5 may for example be a rod element or a beam element, with a fixed spacer length. Alternatively, said spacer length may be adjustable. The at least one spacer element 5 may for example comprise a spacer material, said spacer material may for example be at least one of: a polymer, a ceramic, a metal, or wood. The at least one spacer element 5 may be detachably connected to the back surface 1.

Still referring to FIG. 1A and FIG. 1B, the luminaire 10 according to the invention is configured to be connected to the track 20. When the luminaire 1 is connected to the track 20, in situation II, the connector 3 connects electrically and mechanically to the track 20, and the at least one spacer element 5 contacts the mounting surface 30. This enables the luminaire 10 to be more ergonomically aligned with the mounting surface 30. Moreover, after installation, when the connector 3 of the luminaire 10 is mechanically and electrically connected to the track 20, the at least one spacer element 5 contacts the mounting surface 30 at four respective locations associated with said spacer locations. This will advantageously constraint at least one degree of moment of the luminaire 10, especially a rotation (or: tilt) of the luminaire 10 around the connection point (i.e. the geometric center of the back surface 1) at which the connector 3 is connected to the track 20. The luminaire 10 may therefore be more stably fixed relative to the track 20 and relative to the mounting surface 30, as the luminaire 10 cannot rotate anymore around the geometric center. This is particularly advantageous for large-area luminaires, such as the light panel 10 depicted here.

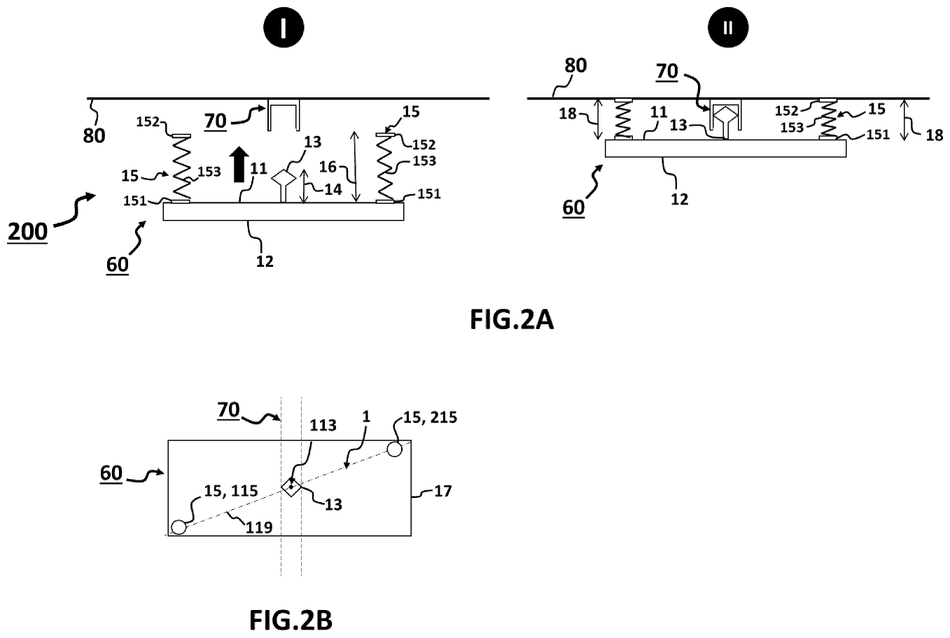

FIG. 2A and FIG. 2B depict schematically, by non-limiting example, an embodiment of a track lighting system 200 according to the invention. The track lighting system 200 comprises a luminaire 60 and a track 70. The luminaire 60 is configured to be mechanically and/or electrically connect to said track 70. FIG. 2A depicts a sideview, of a first situation I in which the luminaire 60 is to be connected to the track 70, and of a second situation II in which the luminaire 60 is connected to the track 70. Furthermore, FIG. 2B depicts schematically, by non-limiting example, a top view of said embodiment.

The track lighting system 200 comprises a luminaire 60 and a track 70. The track 70 is mounted to a mounting surface 80. The track 70 is thereby mounted on the mounting surface 80. Alternatively, the track may at least partly be recessed in said mounting surface. The track 70 may be phrased as a power track. The track may comprise a cathode track and an anode track for powering the luminaire 60. The principles of a track lighting systems as such may be known in the art.

The luminaire 60 according to the invention comprises a back surface 11 and a planar light exit window 12. The planar light exit window 12 conveys light in operation. In aspects, said back surface 11 may also be substantially planar, but that is not necessary. The back surface 11 faces the track 70, and consequently the mounting surface 80, when the luminaire 60 is connected to said track 70. The planar light exit window 12 is arranged opposite to the back surface 11. In the present embodiment, the luminaire 60 is a light panel. Alternatively, the luminaire may be an elongated light bar. The luminaire 60 (i.e. light panel) comprises a rectangular light exit window 12. The back surface 11 of the luminaire 60 comprises outline 17, wherein the outline 17 of the back surface 11 is also rectangular. Alternatively, such outlines may be a square, a triangle, a polygon, a circle, a star, an ellipse, a free-form, or at least a combination of these shapes. For example, a rectangle with rounded corners.

Still referring to FIG. 2A and FIG. 2B, the luminaire 60 comprises a connector 13. The connector 13 is connected to the back surface 11 and protrudes a connector length 14 away from the back surface 11. Here, the connector length 14 is defined in a direction perpendicular to the planar light exit window 12. The connector length 14 is thereby defined as the shortest distance between the location where the connector 13 (is connected and) protrudes away from the back surface 11 and an (free extending) utmost point of the connector 13. The connector 13 is configured to connect the luminaire 60 mechanically and electrically to said track 70. Such connections are known in the art. In the present embodiment, the connector 13 is fixed, but alternatively may be adjustable in connector length.

According to the invention, the luminaire 60 further comprises at least one spacer element 15. The at least one spacer element 15 is connected to the back surface 11 and protrudes a spacer length 16, 18 away from the back surface 11. The spacer length 16, 18 is also defined in a direction perpendicular to the planar light exit window 12.

As mentioned, the at least one spacer element 15 is connected to the back surface 11 and protrudes a spacer length 16, 18 away from the back surface 11. More specifically, the at least one spacer element 15 comprises a base 151 connected to the back surface 11, a tip 152, and a body 153 extending between said base 151 and said tip 152. The at least one spacer element 15, and here in particular the tip 152, contacts (or: is configured to contact) the mounting surface 80 when the luminaire 60 is connected to said track 70. See situation referred as II. In aspects, the second spacer length 18 may at least be a factor 1.2 shorter than the first spacer length 16.

Albeit optionally, the tip 152 of the at least one spacer element 15 comprises a rubber or a textile. Hence, when the luminaire 60 is connected to said track 70, the tip 152 does not damage the mounting surface 80 with said contact.

Still referring to FIG. 2A and FIG. 2B, the depicted embodiment is characterized in that the at least one spacer element 15 is adjustable, namely the at least one spacer element 15 is adjustable from a first spacer length 16 to a second spacer length 18. The body 153 of the at least one spacer element 15 is configured to elastically deform upon forced. Here, the body 153 of the at least one spacer element 15 comprises a spring to elastically deform the at least one spacer element 15 upon forced. Alternatively, said spring may be a rubber, or any other plastically deformable rod or beam.

Hence, the spacer length of the at least one spacer element 15 is adjustable from the first spacer length 16 to the second spacer length 18 by controlling a force on the tip 152. Namely, in the present embodiment, said force emanates from the reactive force of the mounting surface 80 acting on the tip 152, as the at least one spacer element 15 contacts the mounting surface 80, when connecting the luminaire 60 to the track 70. The spring of the body 153 is thus compressed when the tip 152 is forced towards the base 151 when connecting the luminaire 60 to the track 70. Hence, the spacer length of the at least one spacer element 15 is adjustable from the first spacer length 16 to the second spacer length 18 by forcing the tip 152 towards the base 151. Hence, the second spacer length 18 is shorter than the first spacer length 16.

Here, referring to FIG. 2B, the at least one spacer element 15 consists of a first spacer element 115 and a second spacer element 215 connected to the back surface 11. The back surface 11 comprises a geometric center 113. The connector 13 is arranged at said geometric center. The first spacer element 115 and the second spacer element 215 are arranged opposite to each other, on a diagonal 119 crossing the geometric center of the back surface 11, namely are arranged in opposite corner (areas) defined by said rectangular outline 17. The first spacer element 115 and the second spacer element 215 are thus symmetric to each other relative to a symmetry plane through the geometric center. The at least one spacer element 15 (i.e. the first spacer element 115 and the second spacer element 215) are thereby arranged closer to the outline 17 of the back surface 11 than to the connector 13. Alternatively, said luminaire may comprise one, three, or at least four spacer elements. The spacer length may alternatively be defined as the distance between the base and said tip.

The at least one spacer element 15 may for example comprise a spacer material, said spacer material may for example be at least one of: a polymer, a ceramic, a metal, or wood. The at least one spacer element 5 may be detachable connected to the back surface 1.

Still referring to FIG. 2A and FIG. 2B, the luminaire 60 according to the invention is configured to be connected to the track 70. When the luminaire 60 is connected to the track 70, in situation II as depicted, the connector 13 connects electrically and mechanically to the track 70, and the (tip 152 of the) at least one spacer element 15 contacts the mounting surface 80. This enables the luminaire 60 to be more ergonomically aligned with the mounting surface 80. Moreover, after installation, when the connector 13 of the luminaire 60 is mechanically and electrically connected to the track 70, the at least one spacer element 15 contacts the mounting surface 80 at two respective locations. This will advantageously constraint or suppress at least one degree of moment of the luminaire 60, especially a rotation (or: tilt) of the luminaire 60, for example around the axis of elongation of the elongated track 70. The luminaire 60 may therefore be more stably fixed relative to the track 70 and relative to the mounting surface 80, as the luminaire 60 cannot rotate anymore around the geometric center 113 (in the plane of the diagonal 119) or is suppressed to rotate around the geometric center 113. This is particularly advantageous for large-area luminaires, such as the light panel 60 depicted here.

Another advantage is that the at least one spacer element 15 is adjustable in spacer length from the first spacer length 16 to the second spacer length 18, as caused by elastic deformation of said spring. When connecting the luminaire 60 to the track 70, the at least one spacer element 15 contacts the mounting surface 80 before the connector 13 is mechanically and electrically connected to the track 70. This enables alignment, support, but also tactile feedback, for an installer connecting (or: mounting) the luminaire 60 to the track 70. Due to said tactile feedback, for example, the installer may learn that the connector 13 of the luminaire 70 approaches a corresponding connection point relative to the track 70 when the tactile feedback of the at least one spacer element 15 (arising from the at least one spacer element 15 making contact with the mounting surface 80) is experienced.

Furthermore, any skewed alignment of the luminaire 60 may be more easily be noted by an installer during installation. Namely, in some envisioned examples, when the luminaire 60 is connected to the track 70 under a skewed angle relative to the mounting surface 80, the first spacer element 115 of the at least one spacer element 15 may be adjusted in spacer length (i.e. deform or contract) before another, second, spacer element 215 of the at least one spacer element 15. This may enable an installer to experience a larger (reactive) force at the location of the first spacer element 115 before the second spacer element 215, thereby receiving tactile feedback that the luminaire 60 may not be aligned relative to the mounting surface 80.

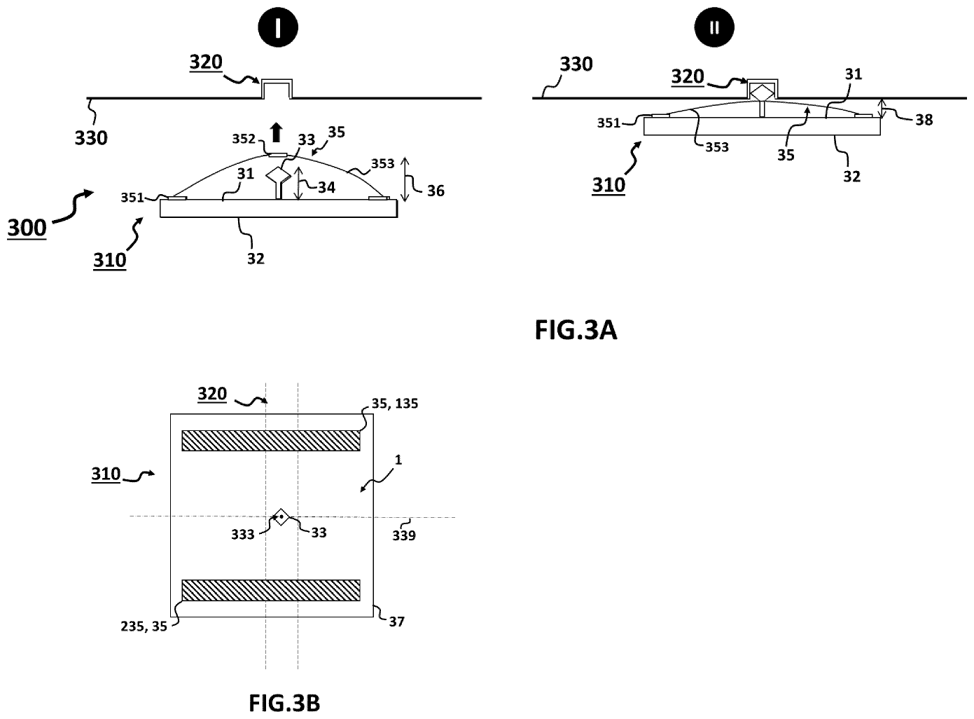

FIG. 3A and FIG. 3B depict schematically, by non-limiting example, an embodiment of a track lighting system 300 according to the invention. The track lighting system 300 comprises a luminaire 310 and a track 320. The luminaire 310 is configured to be mechanically and/or electrically connect to said track 320. FIG. 3A depicts a sideview, of a first situation I in which the luminaire 310 is to be connected to the track 320, and of a second situation II in which the luminaire 310 is connected to the track 320. Furthermore, FIG. 2B depicts schematically, by non-limiting example, a top view of said embodiment.

The track lighting system 300 comprises a luminaire 310 and a track 320. The track 320 is mounted to a mounting surface 330. The track 320 is thereby recessed in mounting surface 330. Alternatively, the track may be mounted on said mounting surface. The track 320 may be phrased as a power track. The track may comprise a cathode track and an anode track for powering the luminaire 310. The principles of a track lighting systems as such may be known in the art.

The luminaire 310 according to the invention comprises a back surface 31 and a planar light exit window 32. The planar light exit window 32 conveys light in operation. In aspects, said back surface 31 may also be substantially planar, but that is not necessary. The back surface 31 faces the track 320, and consequently the mounting surface 330, when the luminaire 310 is connected to said track 320. The planar light exit window 32 is arranged opposite to the back surface 31. In the present embodiment, the luminaire 310 is a light panel. Alternatively, the luminaire may be an elongated light bar. The luminaire 310 (i.e. light panel) comprises a square light exit window 32. The back surface 31 of the luminaire 310 comprises outline 37, wherein the outline 37 of the back surface 31 is also square. Alternatively, such outlines may be a rectangle, a triangle, a polygon, a circle, a star, an ellipse, a free-form, or at least a combination of these shapes. For example, a rectangle with rounded corners.

Still referring to FIG. 3A and FIG. 3B, the luminaire 310 comprises a connector 33. The connector 33 is connected to the back surface 31 and protrudes a connector length 34 away from the back surface 31. Here, the connector length 34 is defined in a direction perpendicular to the planar light exit window 32. The connector length 34 is thereby defined as the shortest distance between the location where the connector 33 (is connected and) protrudes away from the back surface 31 and an (free extending) utmost point of the connector 33. The connector 33 is configured to connect the luminaire 310 mechanically and electrically to said track 320. Such connections are known in the art. In the present embodiment, the connector 13 is fixed, but alternatively may be adjustable in connector length.

According to the invention, the luminaire 310 further comprises at least one spacer element 35. The at least one spacer element 35 is connected to the back surface 31 and protrudes a spacer length 36, 38 away from the back surface 31. The spacer length 36, 38 is also defined in a direction perpendicular to the planar light exit window 32.

As mentioned, the at least one spacer element 15 is connected to the back surface 31 and protrudes a spacer length 36, 38 away from the back surface 31. More specifically, the at least one spacer element 35 is a bendable sheet metal, for example a plate spring assembly.

The at least one spacer element 35 therefore comprises a base 351 connected to the back surface 31, a tip 352, and a body 353 extending between said base 351 and said tip 352. The body 353 comprises a plate spring. The base 351 is split between a first foot base and a second foot base, between which a plate spring 353 is spanned. Here, the tip 352 is the utmost edge, or surface part, extending away from the base 351 of the bendable sheet metal 35. The at least one spacer element 35, and here in particular the tip 352, contacts (or: is configured to contact) the mounting surface 330 when the luminaire 310 is connected to said track 320. See situation referred as II. Albeit optionally, the tip 352 of the at least one spacer element 35 comprises a rubber or a textile. Hence, when the luminaire 310 is connected to said track 330, the tip 352 does not damage the mounting surface 330 with said contact.

Still referring to FIG. 3A and FIG. 3B, the depicted embodiment is characterized in that the at least one spacer element 35 is adjustable, namely the at least one spacer element 35 is adjustable from a first spacer length 36 to a second spacer length 38. The body 353 of the at least one spacer element 35 is configured to elastically deform upon forced. Hence, the body 353 of the at least one spacer element 35, namely the plate spring, is configured to elastically deform (as common for plate springs) upon forced.

Hence, the spacer length of the at least one spacer element 35 is adjustable from the first spacer length 36 to the second spacer length 38 by controlling a force on the tip 352. In aspects, the second spacer length 38 may at least be a factor 1.2 shorter than the first spacer length 36.

Namely, in the present embodiment, said force emanates from the reactive force of the mounting surface 330 acting on the tip 352, as the at least one spacer element 35 contacts the mounting surface 330, when connecting the luminaire 310 to the track 320. The plate spring of the body 353 is thus compressed when the tip 352 is forced towards the base 351 when connecting the luminaire 310 to the track 320. Hence, the spacer length of the at least one spacer element 35 is adjustable from the first spacer length 36 to the second spacer length 38 by forcing the tip 352 towards the base 351. Hence, the second spacer length 38 is shorter than the first spacer length 36.

Here, referring to FIG. 3B, the at least one spacer element 35 consists of a first spacer element 135 and a second spacer element 235 connected to the back surface 31. The back surface 31 comprises a geometric center 333. The connector 13 is arranged at said geometric center 333. The first spacer element 135 and the second spacer element 235 are arranged opposite to each other on the back surface 31. The first spacer element 135 and the second spacer element 235 are symmetric to each other relative to a symmetry plane 339 through the geometric center 333. The at least one spacer element 35 (i.e. the first spacer element 135 and the second spacer element 235) are thereby arranged closer to the outline 37 of the back surface 31 than to the connector 33.

Alternatively, said luminaire may comprise one, three, or at least four spacer elements. Here, albeit optionally, the at least one spacer element 35 may be detachable connected to the back surface 31. Alternatively, the at least one spacer element may be monolithic with said back surface, hence the bendable sheet metal and associated plate spring may be cut from a single piece of material constituting the back surface.

Still referring to FIG. 3A and FIG. 3B, the luminaire 310 according to the invention is configured to be connected to the (recessed) track 320. When the luminaire 310 is connected to the track 320, in situation II as depicted, the connector 33 connects electrically and mechanically to the track 320, and the (tip 352 of the) at least one spacer element 35 contacts the mounting surface 330. This enables the luminaire 310 to be more ergonomically aligned with the mounting surface 330. Moreover, after installation, when the connector 33 of the luminaire 310 is mechanically and electrically connected to the track 320, the at least one spacer element 35 contacts the mounting surface 330 at two respective locations. This will advantageously constraint or suppress at least one degree of moment of the luminaire 310, especially a rotation (or: tilt) of the luminaire 310, for example around the axis of elongation of the elongated track 320. The luminaire 310 may therefore be more stably fixed relative to the track 320 and relative to the mounting surface 330, as the luminaire 310 is suppressed to rotate anymore around the geometric center 333 and said symmetry line 339. The force of the plate spring will prohibit this to a degree. This is particularly advantageous for large-area luminaires, such as the light panel 310 depicted here.

Another advantage is that the at least one spacer element 35 is adjustable in spacer length from the first spacer length 36 to the second spacer length 38, as caused by elastic deformation of said plate spring. When connecting the luminaire 310 to the track 320, the at least one spacer element 35 contacts the mounting surface 330 before the connector 33 is mechanically and electrically connected to the track 320. This enables alignment, support, but also tactile feedback, for an installer connecting (or: mounting) the luminaire 310 to the track 320. Due to said tactile feedback, for example, the installer may learn that the connector 33 of the luminaire 310 approaches a corresponding connection point relative to the track 320 when the tactile feedback of the at least one spacer element 35 (arising from the at least one spacer element 35 making contact with the mounting surface 330) is experienced.

Furthermore, any skewed alignment of the luminaire 310 may be more easily be noted by an installer during installation. Namely, in some envisioned examples, when the luminaire 310 is connected to the track 320 under a skewed angle relative to the mounting surface 330, the first spacer element 135 of the at least one spacer element 35 may be adjusted in spacer length (i.e. deform or contract) before another, second, spacer element 235 of the at least one spacer element 35. This may enable an installer to experience a larger (reactive) force at the location of the first spacer element 135 before the second spacer element 235, thereby receiving tactile feedback that the luminaire 310 may not be aligned relative to the mounting surface 330.

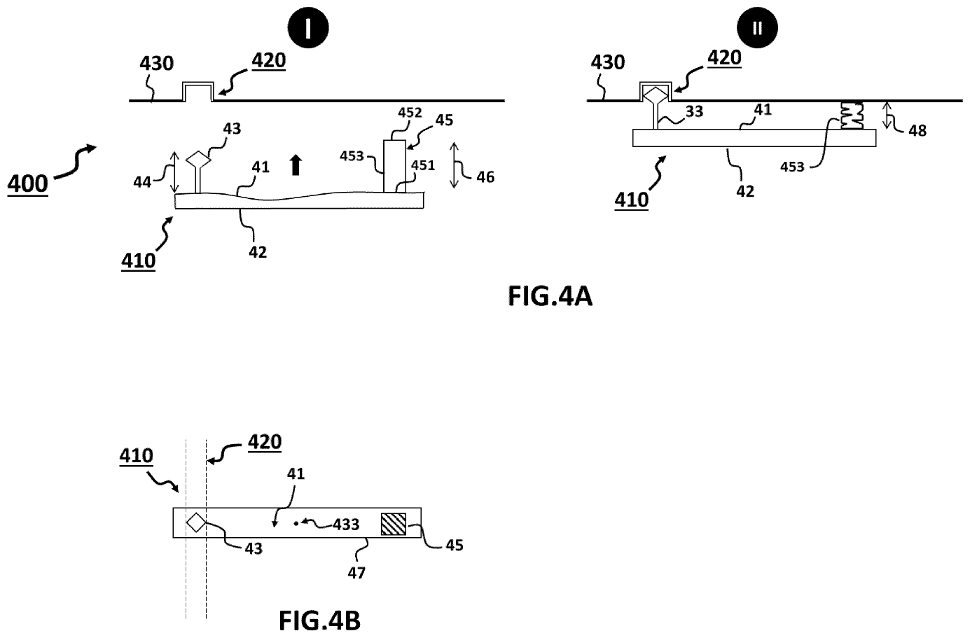

FIG. 4A and FIG. 4B depict schematically, by non-limiting example, an embodiment of a track lighting system 400 according to the invention. The track lighting system 400 comprises a luminaire 410 and a track 420. The luminaire 410 is configured to be mechanically and/or electrically connect to said track 420. FIG. 4A depicts a sideview, of a first situation I in which the luminaire 410 is to be connected to the track 420, and of a second situation II in which the luminaire 410 is connected to the track 420. Furthermore, FIG. 2B depicts schematically, by non-limiting example, a top view of said embodiment.

The track lighting system 400 comprises a luminaire 410 and a track 420. The track 420 is mounted to a mounting surface 430. The track 420 is thereby recessed in mounting surface 4. Alternatively, the track may be mounted on said mounting surface. The track 420 may be phrased as a power track. The track may comprise a cathode track and an anode track for powering the luminaire 410. The principles of a track lighting systems as such may be known in the art.

The luminaire 410 according to the invention comprises a back surface 41 and a planar light exit window 42. The planar light exit window 42 conveys light in operation. In aspects, said back surface 41 may also be substantially planar, but that is not necessary. Here, the back surface 41 comprises a slightly curved surface as an example. The back surface 41 faces the track 420, and consequently the mounting surface 430, when the luminaire 410 is connected to said track 420. The planar light exit window 42 is arranged opposite to the back surface 41. The planar light exit window 42 may thus serve as a reference plane.

In the present embodiment, the luminaire 410 is an elongated light bar. Alternatively, the luminaire may be an elongated light panel. The luminaire 410 (i.e. light bar) comprises a rectangular light exit window 42 with a relatively high aspect ratio length vs width. For example, the length may be at least ten times longer than said width, and/or said height. The back surface 41 of the luminaire 410 comprises outline 47, wherein the outline 47 of the back surface 41 is also a rectangle.

Still referring to FIG. 4A and FIG. 4B, the luminaire 410 comprises a connector 43. The connector 43 is connected to the back surface 41 and protrudes a connector length 44 away from the back surface 41. Here, the connector length 44 is defined in a direction perpendicular to the planar light exit window 42. The connector length 44 is thereby defined as the shortest distance between the location where the connector 43 (is connected and) protrudes away from the back surface 41 and an (free extending) utmost point of the connector 43. The connector 43 is configured to connect the luminaire 410 mechanically and electrically to said track 420. Such connections are known in the art. In the present embodiment, the connector 43 is fixed, but alternatively may be adjustable in connector length.

According to the invention, the luminaire 410 further comprises at least one spacer element 45. The at least one spacer element 45 is connected to the back surface 41 and protrudes a spacer length 46, 48 away from the back surface 41. The spacer length 46, 48 is also defined in a direction perpendicular to the planar light exit window 42.

As mentioned, the at least one spacer element 45 is connected to the back surface 41 and protrudes a spacer length 46, 48 away from the back surface 41. The at least one spacer element 45 comprises a base 451 connected to the back surface 41, a tip 452, and a body 453 extending between said base 451 and said tip 452. The body 453 is configured such as to plastically deform upon forced. The at least one spacer element 45, and here in particular the tip 452, contacts (or: is configured to contact) the mounting surface 430 when the luminaire 410 is connected to said track 420. See situation referred as II.

Albeit optionally, the tip 452 of the at least one spacer element 45 comprises a rubber or a textile. Hence, when the luminaire 410 is connected to said track 430, the tip 452 does not damage the mounting surface 430 with said contact.

Still referring to FIG. 3A and FIG. 3B, the depicted embodiment is characterized in that the at least one spacer element 45 is adjustable, namely the at least one spacer element 45 is adjustable from a first spacer length 46 to a second spacer length 48. The body 453 of the at least one spacer element 45 is namely configured to plastically deform upon forced. The body 453 may for example comprise a plastically deformable polymer, plastically deformable metal, or a plastically deformable metal structure. The spacer length is adjustable from a first spacer length 46 to a second spacer length 48 by controlling a force on the tip 452

Hence, the spacer length of the at least one spacer element 45 is adjustable from the first spacer length 46 to the second spacer length 48 by controlling a force on the tip 452.

Namely, in the present embodiment, said force emanates from the reactive force of the mounting surface 430 acting on the tip 452, as the at least one spacer element 45 contacts the mounting surface 430, when connecting the luminaire 410 to the track 420. The plastically deformable body 453 is thus compressed when the tip 452 is forced towards the base 451 when connecting the luminaire 410 to the track 420. Hence, the spacer length of the at least one spacer element 45 is adjustable from the first spacer length 46 to the second spacer length 48 by forcing the tip 452 towards the base 451. Hence, the second spacer length 48 is shorter than the first spacer length 46.

In the present embodiment, albeit optionally, the second spacer length 48 is at least a factor 1.2 shorter than the first spacer length 46, and the second spacer length 48 is at most be a factor 2.4 shorter than the first spacer length 46. Hence, said plastic deformation may comprise a limit.

Here, referring to FIG. 4B, the at least one spacer element 45 consists of only one spacer element 45. Here, as an example, the back surface 41 of the light bar 410 comprises a geometric center 433. The connector 43 is arranged at one side of said geometric center 433, while the one spacer element 45 is arranged at the (diametrically opposite) other side of the of the geometric center 433. Hence, substantially one end of the elongated light bar 410 comprises the connector 43 and another end of the elongated light bar 410 comprises the at least one spacer element 45.

Still referring to FIG. 4A and FIG. 4B, the luminaire 410 according to the invention is configured to be connected to the (recessed) track 420. When the luminaire 410 is connected to the track 420, in situation II as depicted, the connector 43 connects electrically and mechanically to the track 420, and the (tip 452 of the) at least one spacer element 45 contacts the mounting surface 430. After installation, when the connector 43 of the luminaire 410 is mechanically and electrically connected to the track 420, the at least one spacer element 45 contacts the mounting surface 430 at two respective locations. This will advantageously constraint or suppress at least one degree of moment of the luminaire 410, especially a rotation (or: tilt) of the luminaire 410, here for example around the axis of elongation of the elongated track 420. The luminaire 410 may therefore be more stably fixed relative to the track 420 and relative to the mounting surface 430, as the luminaire 410 is suppressed to rotate towards the mounting surface 430. The plastically deformed spacer element 45, as depicted in situation II, will prohibit this to a certain degree. This is particularly advantageous for large-area luminaires, such as the light bar 410 depicted here.

Another advantage is that the at least one spacer element 45 is adjustable in spacer length from the first spacer length 46 to the second spacer length 48, as caused by plastic deformation of said body 453. When connecting the luminaire 410 to the track 420, the at least one spacer element 45 contacts the mounting surface 430 before the connector 43 is mechanically and electrically connected to the track 420. This enables alignment, support, but also tactile feedback, for an installer connecting (or: mounting) the luminaire 410 to the track 420. Due to said tactile feedback, for example, the installer may learn that the connector 43 of the luminaire 410 approaches a corresponding connection point relative to the track 420 when the tactile feedback of the at least one spacer element 45 (arising from the at least one spacer element 45 making contact with the mounting surface 430) is experienced.

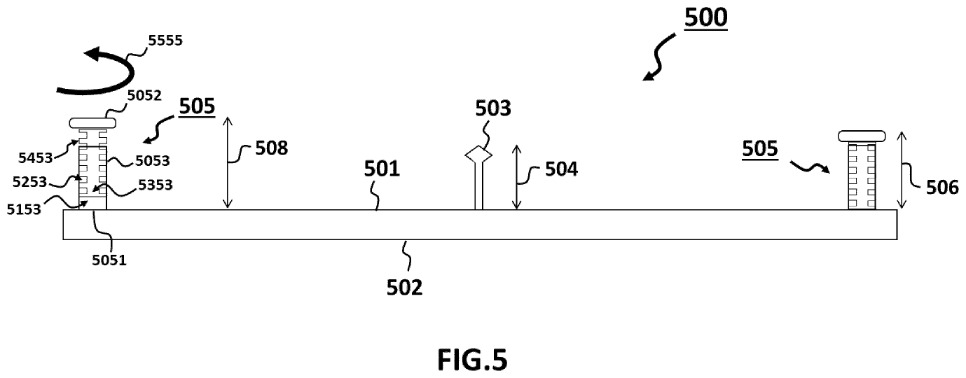

FIG. 5 depicts schematically, by non-limiting example, a luminaire 500 according to the invention, wherein the luminaire 500 comprises a back surface 501. The back surface 501 is configured to face a track of a track lighting system when the luminaire 500 is connected to said track. Said luminaire 500 may be connected to the track of the track lighting system as depicted in FIGS. 1 to 4.

The luminaire 500 further comprises a planar light exit window 502, a connector 503 and at least one spacer element 505. The planar light exit window 502 is arranged opposite to the back surface 501. Here, the luminaire 500 is a (large-area) light panel. The connector 503 is connected to the back surface 501 and protrudes a connector length 504 away from the back surface 501. Here, the connector length 504 is fixed, but may alternatively be adjustable from a first connector length to a second connector length. The connector 503 is configured to connect the luminaire mechanically and electrically to a track of a track lighting system. For example, the track lighting system as depicted in FIGS. 1 to 4.

The at least one spacer element 505 is also connected to the back surface 501 and protrudes a spacer length 506, 508 away from the back surface 501. The at least one spacer element 505 is configured to contact a mounting surface when the luminaire 500 is connected to said track.

Still referring to FIG. 5, the spacer length 506, 508 is adjustable from a first spacer length 506 to a second spacer length 508, and vice versa. FIG. 5 depicts a first spacer element 505 at a first spacer length 506, and a second spacer element 505 at a second spacer length 508, both spacer elements 505 are the same.

The at least one spacer element 505 thereby comprises a base 5051 connected the back surface 501, a tip 5052 configured to contact the mounting surface when the luminaire 500 is connected to said track, and a body 5053 extending between said base 5051 and said tip 5052.

More specifically, here, the body 5053 comprises a socket 5153 comprising an inner thread 5253 and a rod 5353 comprising an outer thread 5453. The rod 5353 is coaxial with said socket 5153. The outer thread 5453 of the rod 5353 engages the inner thread 5253 of the socket 5153. The rod 5353 is thereby configured to move in a direction towards the base 5051 by rotating the rod 5353 in a first rotational direction within the socket 5153. The rod 5353 is thereby configured to move in direction away from the base 5051 by rotating the rod 5353 in a second rotational direction 5555 within the socket 5153. The second rotational direction 5555 is opposite to the first rotational direction. Hence, for the first rotational direction for example being clockwise, the second rotational direction 5555 will be anti-clockwise. The spacer length 506, 508 is thus adjustable from the first spacer length 506 to the second spacer length 508 by rotating the rod 5353 within the socket 5153.

Albeit optionally, the tip 5052 of the at least one spacer element 505 comprises a rubber or a textile. Hence, when the luminaire 500 is connected to said track, the tip 5052 does not damage the mounting surface with said contact.

As the at least one spacer element 505 is adjustable in spacer length from the first spacer length 506 to the second spacer length 508, or vice versa, the at least one spacer element 505 may be tailored to align the contact points of the luminaire 500 with a mounting surface. When connecting the luminaire 500 to a track 502 with the connector 503, the at least one spacer element 505 contacts the mounting surface, or can be adjusted to contact the mounting surface. This enables alignment and support.

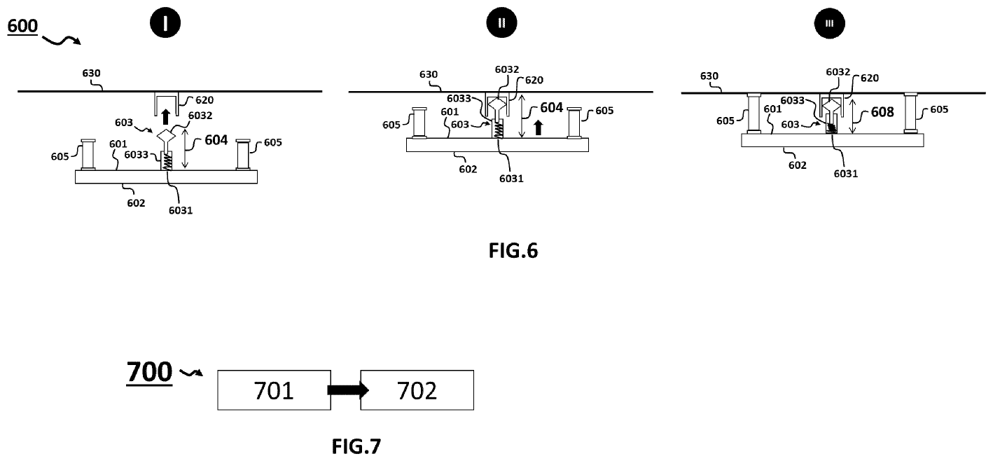

FIG. 6 depicts schematically, by non-limiting example, an embodiment of a track lighting system 600 according to the invention. The track lighting system 600 comprises a luminaire 610 and a track 620. The luminaire 610 is configured to be mechanically and/or electrically connect to said track 620. The track 620 is mounted to a mounting surface 630. The track 620 is thereby mounted on the mounting surface 630. Alternatively, the track may be at least partially recessed in the mounting surface. The track 20 may be phrased as a power track. The track may comprise a cathode track and an anode track for powering the luminaire 10. The principles of a track lighting systems as such may be known in the art.

The luminaire 610 according to the invention comprises a back surface 601 and a planar light exit window 602. The planar light exit window 602 conveys light in operation. In aspects, said back surface may also be substantially planar, but that is not necessary. The back surface 601 faces the track 620, and consequently the mounting surface 630, when the luminaire 610 is connected to said track 620. The planar light exit window 602 is arranged opposite to the back surface 601. In the present embodiment, the luminaire 610 is a light panel. Alternatively, the luminaire may be an elongated light bar.

Still referring to FIG. 6, the luminaire 610 comprises a connector 603. The connector 603 is connected to the back surface 601 and protrudes a connector length 604, 608 away from the back surface 601. Here, the connector length 604, 608 is defined in a direction perpendicular to the planar light exit window 602. The connector 603 is configured to connect the luminaire 610 mechanically and electrically to the track 620.

Moreover, the luminaire 610 comprises at least one spacer element 605. The at least one spacer element 605 is connected to the back surface 601 and protrudes a spacer length 606 away from the back surface 601. The spacer length 606 is also defined in a direction perpendicular to the planar light exit window 602. Here, the at least one spacer element 605 is for example a rod element with a fixed spacer length. The at least one spacer element 605 may be detachably connected to the back surface 601. Alternatively, at least one spacer element 605 may be a spacer element according to the present invention, for example a spacer element as previously mentioned in FIGS. 1 to 5.

Still referring to FIG. 6, the back surface 601 comprises a geometric center. The connector 603 is arranged at said geometric center. Alternatively, the connector may be offset from said geometric center. The at least one spacer element 605 is arranged around said geometric center, and around said connector 603, at the edge regions of said light panel 610.

According to the invention, the connector 603 comprises an adjustable connector length 604, 608. Namely, the connector length is adjustable from a first connector length 604 to a second connector length 608. Here, in the present example as depicted, the first connector length 604 protrudes further away from the back surface 601 than the at least one spacer element 605.

More specifically, the connector 603 comprises a foot 6031 connected to the back surface 601, a head 6032 configured to connect the luminaire 610 mechanically and electrically to said track 620, an extendable member 6033 extending between said foot 6031 and said head 6032. The extendable member 6033 comprises a spring lock (mechanism) configured to switch between a locked state and a released state. Such spring locks, or spring lock mechanisms, may be known in the art as such. Thereby, in the locked state, the connector 603 has the first connector length 604; and in the released state, the connector 603 has the second connector length 608. The second connector length 608 is shorter than the first connector length 604. As mentioned, the connector length 604, 608 is defined in a direction perpendicular to the planar light exit window 602, and may be considered as the shortest distance between the head 6032 and the back surface 601. In aspects, the second connector length 604 may at least be a factor 1.2 shorter than the first connector length 608.

FIG. 6 depicts a first situation I in which the luminaire 610 is to be connected to the track 620, a second situation II in which the luminaire 610 is connected to the track 620 with the connector, and a situation III in which the connector 603 pulls the luminaire 610 toward the track 620 and the mounting surface 630, thereby adjusting the first connector length 604 to the second connector length 608.

As a consequence, when the luminaire 610 is connected to the track 620, in situation II and situation III, the connector 603 not only connects electrically and mechanically to the track 620, but also pulls the luminaire towards the track 620 and the mounting surface 630 on which the track 620 is mounted 630, thereby ensuring that the at least one spacer element 605 contacts the mounting surface 630. This enables the luminaire 610 comprising such spacer elements 605 to be more ergonomically mounted to the mounting surface 30.

FIG. 7 depicts schematically, by non-limiting example, a method of connecting a luminaire according to any one of the preceding embodiments as depicted in FIGS. 1 to 6 to a track of a track lighting system that is mounted to a mounting surface. The method 700 comprises a first step 701 of mechanically and electrically connecting the luminaire to said track. The method comprises a second step 702 of adjusting a first spacer length of the at least one spacer element to a second spacer length of the at least one spacer element.

1. A track lighting system comprising
a track that is mounted to a mounting surface;
a luminaire configured to be connected to a track of a track lighting system that is mounted to a mounting surface, wherein the luminaire comprises:
a back surface facing the track when the luminaire is connected to said track;
a planar light exit window arranged opposite to the back surface;
a connector connected to the back surface and protruding a connector length away from the back surface, wherein the connector is configured to connect the luminaire mechanically and electrically to said track;
at least one spacer element connected to the back surface and protruding a spacer length away from the back surface, wherein the at least one spacer element is configured to contact the mounting surface when the luminaire is connected to said track;
wherein the luminaire is mechanically and electrically connected to said track, wherein the at least one spacer element of said luminaire contacts the mounting surface when the luminaire is connected to said track

2. The track lighting system according to claim 1, wherein the spacer length of the at least one spacer element is adjustable from a first spacer length to a second spacer length.

3. The track lighting system according to claim 2, wherein the at least one spacer element comprises: a base connected to the back surface, a tip configured to contact the mounting surface when the luminaire is connected to said track, a body extending between said base and said tip.

4. The track lighting system according to claim 3, wherein the body is configured to elastically deform upon forced;
wherein the spacer length of the at least one spacer element is adjustable from the first spacer length to the second spacer length by controlling a force on the tip.

5. The track lighting system according to claim 4, wherein the body comprises a spring configured to elastically deform upon forced;
wherein the spacer length of the at least one spacer element is adjustable from the first spacer length to the second spacer length by forcing the tip towards the base.

6. The track lighting system according to claim 4, wherein the body comprises a rubber configured to elastically deform upon forced;
wherein the spacer length of the at least one spacer element is adjustable from the first spacer length to the second spacer length by forcing the tip towards the base.

7. The track lighting system according to claim 3, wherein the body is configured to plastically deform upon forced;
wherein the spacer length of the at least one spacer element is adjustable from the first spacer length to the second spacer length by controlling a force on the tip.

8. The track lighting system according to claim 2, wherein the second spacer length is shorter than the first spacer length.

9. The track lighting system according to claim 3, wherein the body comprises a socket comprising an inner thread and a rod comprising an outer thread;
wherein the rod is arranged coaxial with the socket;
wherein the outer thread of the rod engages the inner thread of the socket;
wherein the rod is configured to move in a direction towards to the base by rotating the rod in a first rotational direction within the socket, and
wherein the rod is configured to move in a direction away from the base by rotating the rod in a second rotational direction within the socket;
wherein the second rotational direction is opposite to the first rotational direction;
wherein the spacer length of the at least one spacer element is adjustable from the first spacer length to the second spacer length by rotating the rod within the socket.

10. The track lighting system according to claim 3, wherein the tip comprises a rubber or a textile.

11. The track lighting system according to claim 1, wherein the spacer length is defined in a direction perpendicular to the planar light exit window.

12. The track lighting system according to claim 1, wherein the back surface comprises an outline;
wherein the at least one spacer element is arranged closer to the outline than to the connector.

13. The track lighting system according to claim 1, wherein the connector length of the connector is adjustable from a first connector length to a second connector length.

14. The track lighting system according to claim 13, wherein the connector comprises: a foot connected to the back surface, a head configured to connect the luminaire mechanically and electrically to said track, an extendable member extending between said foot and said head;
wherein the extendable member comprises a spring lock configured to switch between a locked state and a released state;
wherein, in the locked state, the connector has the first connector length;
wherein, in the released state, the connector has the second connector length;
wherein the second connector length is shorter than the first connector length.

15. A luminaire configured to be connected to a track of a track lighting system that is mounted to a mounting surface, wherein the luminaire comprises:
a back surface facing the track when the luminaire is connected to said track;
a planar light exit window arranged opposite to the back surface;
a connector connected to the back surface and protruding a connector length away from the back surface, wherein the connector is configured to connect the luminaire mechanically and electrically to said track;
at least one spacer element connected to the back surface and protruding a spacer length away from the back surface, wherein the at least one spacer element is configured to contact the mounting surface when the luminaire is connected to said track;
wherein the connector length of the connector is adjustable from a first connector length to a second connector length;
wherein the connector comprises: a foot connected to the back surface, a head configured to connect the luminaire mechanically and electrically to said track, an extendable member extending between said foot and said head;
wherein the extendable member comprises a spring lock configured to switch between a locked state and a released state;
wherein, in the locked state, the connector has the first connector length;
wherein, in the released state, the connector has the second connector length;
wherein the second connector length is shorter than the first connector length.
